(19) United States
(12) Patent Application Publication
(10) Pub. No.: US 2024/0362061 A1
(43) Pub. Date: Oct. 31, 2024

(54) MECHANISM FOR SHARING A COMMON RESOURCE IN A MULTI-THREADED ENVIRONMENT

(71) Applicant: TEXAS INSTRUMENTS INCORPORATED, Dallas, TX (US)

(72) Inventors: Peter Wongeun CHUNG, Frisco, TX (US); Brian QUACH, Richardson, TX (US); Jackson FARLEY, Dallas, TX (US); Jonathan NAFZIGER, Dallas, TX (US)

(21) Appl. No.: 18/309,604

(22) Filed: Apr. 28, 2023

(51) Int. Cl. G06F 9/48; G06F 9/50

(52) U.S. Cl. CPC G06F 9/4831; G06F 9/5038

(57) ABSTRACT

In an example, a method includes adding a first request from a first requestor to a queue for a shared resource, where the first request has a first priority. The method includes providing the first request to the shared resource from the queue. The method includes processing the first request at the shared resource. The method includes adding a second request from a second requestor to the queue for the shared resource, where the second request has a second priority that is higher than the first priority. The method includes preempting the processing of the first request and notifying the first requestor of the preemption, where notifying the first requestor of the preemption includes providing the first requestor with a duration of availability for the shared resource. The method includes providing the second request to the shared resource from the queue and processing the second request at the shared resource.

### BACKGROUND

Some electronic devices may include components that are shared amongst multiple circuits, processors, applications, or contexts. For example, multi-core processors implemented in a single integrated circuit may include two or more processing units that each reads and executes program instructions independently. Other components in the integrated circuit may be shared between the two or more processing units, such as an antenna, a math coprocessor, a graphics processor, or a cryptographic hardware accelerator.

### SUMMARY

In accordance with at least one example of the description, a method includes adding a first request from a first requestor to a queue for a shared resource, where the first request has a first priority. The method also includes providing the first request to the shared resource from the queue. The method includes processing the first request at the shared resource. The method also includes adding a second request from a second requestor to the queue for the shared resource, where the second request has a second priority that is higher than the first priority. The method includes preempting the processing of the first request and notifying the first requestor of the preemption, where notifying the first requestor of the preemption includes providing the first requestor with a duration of availability for the shared resource. The method also includes providing the second request to the shared resource from the queue. The method includes processing the second request at the shared resource.

In accordance with at least one example of the description, a method includes adding a first request from a first requestor to a queue for a shared resource, where the first request has a first priority. The method also includes providing the first request to the shared resource from the queue. The method includes processing the first request at the shared resource. The method also includes adding a second request from a second requestor to the queue for the shared resource, where the second request has a second priority that is higher than the first priority, and the second request also includes a hold time. The method includes, when the shared resource can complete the first request within the hold time, completing the first request and then processing the second request. The method also includes, when the shared resource cannot complete the first request within the hold time, preempting the first request and then processing the second request.

In accordance with at least one example of the description, a method includes adding a plurality of requests from one or more requestors to a queue for a shared resource. The method also includes determining a maximum available transaction length based at least in part on the plurality of requests. The method includes adding a first request from a first requestor to the queue for the shared resource. The method also includes notifying the first requestor that the first request exceeds the maximum available transaction length.

In accordance with at least one example of the description, a system includes a processor configured to add a first request from a first requestor to a queue for a shared resource, where the first request has a first priority. The processor is also configured to add a second request from a second requestor to the queue for the shared resource, where the second request has a second priority that is higher than the first priority. The processor is configured to receive a notification that the first request was preempted. The processor is also configured to, responsive to receiving the notification, add the first request to the queue again for the shared resource.

### BRIEF DESCRIPTION OF THE DRAWINGS

FIG. 1 is a block diagram of a system for sharing a resource in accordance with various examples.

FIG. 2 is block diagram of a system for sharing a resource in accordance with various examples.

FIG. 3 is a timing diagram of low priority request preemption in accordance with various examples.

FIG. 4 is a block diagram of a system for sharing a resource with frequency monitoring in accordance with various examples.

FIG. 5 is a diagram of periodic request frequency monitoring in accordance with various examples.

FIG. 6A is a system for determining an available window duration in accordance with various examples.

FIG. 6B is a timing diagram of a duration of availability in accordance with various examples herein.

FIG. 7 is a flow diagram of a method for sharing a resource in accordance with various examples.

FIG. 8 is a flow diagram of a method for sharing a resource in accordance with various examples.

FIG. 9 is a flow diagram of a method for sharing a resource in accordance with various examples.

The same reference numbers or other reference designators are used in the drawings to designate the same or similar (functionally and/or structurally) features.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the invention(s), and do not limit the scope of the invention(s).

The description below illustrates the various specific details to provide an in-depth understanding of several example embodiments according to the description. The embodiments may be obtained without one or more of the specific details, or with other methods, components, materials and the like. In other cases, known structures, materials or operations are not shown or described in detail so as not to obscure the different aspects of the embodiments. References to “an embodiment” or “an example” in this description indicate that a particular configuration, structure or feature described in relation to the embodiment is included in at least one embodiment. Consequently, phrases such as “in one embodiment” or “in one example” that may appear at different points of the present description do not necessarily refer exactly to the same embodiment. Furthermore, specific formations, structures or features may be combined in any appropriate manner in one or more embodiments.

Computing systems may include resources that are shared among multiple processors, applications, or contexts. A multi-core processor may execute instructions for multiple applications or contexts simultaneously, and each of the multiple applications or contexts may send requests to the shared resources. One shared resource may be an antenna. If a first application sends a first request to the antenna to transmit data, and a second application sends a second request to the antenna to transmit data, both requests have to be handled by the antenna. A queue may be used for managing requests, and the queue may fill up with requests. If the antenna is not free, new requests have to wait for existing requests to complete. The shared resource may also be a cryptographic hardware accelerator (e.g., a cryptographic engine) that receives requests from applications for cryptographic operations. These requests for cryptographic operations may also be held in a queue and/or have to wait for existing requests to complete. Important tasks that require the shared resource may be held up or rejected, which can cause resource conflict errors, missed deadlines, or non-determinism, and thus a simple FIFO queue may not be sufficient in real-time priority systems.

In examples herein, multiple requestors (such as an application, context, processor, processing core, controller, or hardware device) may send requests to a resource manager for a shared resource. The shared resource may be an antenna, a cryptographic engine, a specialized processor, or any other shared resource. The resource manager places the received requests into a priority-aware queue. The requests are executed by the shared resource based on a priority. Higher priority requests are executed before lower priority requests. In some examples, lower priority requests may be preempted by a higher priority request. If the shared resource supports resumption of a preempted request, the lower priority request may be resumed and executed after the higher priority request completes, if no other higher priority requests have been received in the interim. If the shared resource doesn't support preemption and resumption, the lower priority request is rejected and the requestor may be notified. The requestor may re-submit the lower priority request. In some examples, the requestor may re-submit the lower priority request as a set of multiple smaller requests, each with a shorter length, duration, or execution time to attempt to avoid recurring, high-priority preemptions. In some examples, the resource manager may suggest a duration of availability to the requestor. The duration of availability may be an estimate of a maximum transaction length that the shared resource may be able to execute for a lower priority request without expected preemption. The resource manager may determine the duration of availability by monitoring the history of high priority requests and determining if a pattern exists in the timing and duration of the high priority requests. If a pattern is determined, and a duration of availability is found, the resource manager may reject a lower priority request and notify the requestor of the duration of availability. The requestor may then re-submit, or alter and re-submit, the lower priority request for the shared resource. Examples herein provide for lower costs and lower power consumption, as a resource may be shared in a system, rather than duplicating the resource. The examples may also provide a real-time guarantee for critical operations, and the deterministic use of the shared resource.

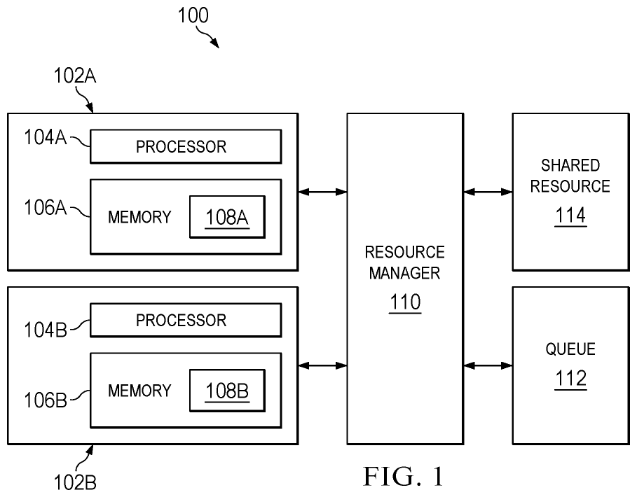

FIG. 1 illustrates a block diagram of a system 100 for sharing a resource in accordance with various examples herein. In this example, system 100 includes a core 102A and a core 102B (collectively, cores 102, or individually, core 102 (e.g., when cores 102A and 102B are implemented as a single core, or when referring to any of cores 102A and 102B)). In other examples, there may be only a single core, or there may be more than two cores. Core 102A includes a processor 104A, memory 106A, and instructions 108A stored in memory 106A. Core 102B includes a processor 104B, memory 106B, and instructions 108B stored in memory 106B. Processors 104A and 104B may be referred to individually as a processor 104 herein (e.g., when processors 104A and 104B are implemented as a single processor, or when referring to any of processors 104A and 104B), or may be referred to collectively as processors 104. Memories 106A and 106B may be referred to individually as a memory 106 (e.g., when memories 106A and 106B are implemented as a single memory, or when referring to any of memories 106A and 106B), or may be referred to collectively as memories 106. In other examples, additional cores 102, processors 104, or memories 106 may be present to perform the examples described herein (not shown in FIG. 1). Various applications, stored in memories 106, may be executed by cores 102 and create tasks or requests for a shared resource.

System 100 also includes a resource manager 110, queue 112, and shared resource 114. Resource manager 110 may be software executed by any processor 104 in system 100 in one example. Queue 112 may be embodied in hardware (e.g., implemented with latches/bits and associated logic) and/or software executed by a processor 104, and is configured to store requests from applications or devices for shared resource 114. Shared resource 114 may be any resource that is shared amongst multiple applications, contexts, processors, controllers, or hardware devices. Shared resource 114 may be an antenna, a cryptographic engine, a specialized processor, or any other shared resource. In some examples herein, shared resource 114 is a cryptographic engine, but other resources may also be shared that fall within the scope of this description. In some examples, one or more processors 104 and shared resource 114 may be integrated in the same integrated circuit. Memories 106 may also be integrated in the same integrated circuit in some examples.

System 100 could be a multi-protocol stack that supports Bluetooth® Low Energy (BLE), Zigbee, controller area network (CAN), and other protocols, as one example. Different protocols may request encryption tasks periodically to communicate amongst devices, make connections, maintain connections, etc. If the requests take too long to execute, problems with the connections may occur. The protocols may not be able to comply with standards to transmit data, receive responses, etc., if cryptographic requests take too long to execute. The examples described herein allow for high priority requests to be executed in a timely manner, and for lower priority requests to be notified of a window for execution.

In an example operation, multiple applications or tasks are running simultaneously in system 100. If an application requires a cryptographic operation provided by shared resource 114, the application sends a request (e.g., a task) to the shared resource 114. Each cryptographic operation may have its own driver that is called to perform the operation. Each request may include or be associated with a priority. Any number of levels of priority may be implemented, such as two (high and low), three (high, medium, and low), or more than three. In some examples, interrupts (or interrupt service routines (ISR)) may also be called that must run to completion and may be treated with the highest priority. The requests may also include an attribute that indicates how the request is to be handled. A first attribute may be that preemption and resumption is allowed. This attribute indicates that a lower priority request may be preempted and then resumed if a higher priority request is received. A second attribute may be preemption and rejection. This attribute indicates that the lower priority request is preempted and then immediately rejected and notifying the requestor of the rejection. When preempted and rejected, the lower priority request is not resumed, and would have to be resubmitted by the application for execution. A third attribute may be to hold the request for up to a certain duration. With this attribute, the lower priority request may be held in queue 112 for a predetermined duration to wait in case the shared resource 114 becomes available. If the duration expires, or it is determined that the duration will expire before the request may be completed, the lower priority request can be rejected and resubmitted. A higher priority request may also have a hold duration, where the higher priority request may hold for a predetermined amount of time to allow a lower priority request to continue execution. At the end of the predetermined amount of time, the higher priority request begins executing, and the currently executing lower priority task is preempted if it has not completed. In some examples, if it is determined that the lower priority task will take longer to complete than the hold time, the higher priority request may begin execution before the predetermined amount of time specified in the hold attribute elapses (e.g., immediately). The attributes and their operation are described in further detail below.

Some shared resources 114 may not support preemption and resumption. Therefore, those shared resources 114 may instead preempt and reject lower priority requests if a higher priority request is received. In some examples, the resource manager 110 may also send a duration of availability to the requesting application of the lower priority request to allow the requesting application to re-submit the request at a time or with a duration where the likelihood increases that the lower priority request will be executed.

A processors, such as processor 104A, 104B, or another processor 104, may perform all or portions of the method described herein. A processor 104 as described herein may include any suitable processor or combination of processors. For example, a processor, such as processor 104A or 104B, may be a central processing unit (CPU), digital signal processor (DSP), a microcontroller unit (MCU), a DSP+MCU processor, a field programmable gate array (FPGA), or an application specific integrated circuit (ASIC). Memories 106 provide storage, e.g., a non-transitory computer readable medium, which may be used, for example, to store software instructions 108 executed by a processor 104, such as any software instructions for implementing the operations described herein. A memory 106 may include any suitable combination of read-only memory (ROM) and/or random access memory (RAM), e.g., static RAM.

Memory 106 may include any suitable data, code, logic, or instructions 108. A processor 104 is configured to read and execute computer-readable instructions. For example, the processor 104 is configured to invoke and execute instructions in a program stored in the memory 106, including instructions 108. Instructions 108 may perform the actions described herein, such as providing requests to shared resource 114 or managing resource manager 110 and queue 112.

In one example, memory 106 may be integrated with the processor 104. Memory 106 is configured to store the instructions 108 for implementing the various methods and processes provided in accordance with the various examples of this description. In another example, a processor 104 disclosed herein may use any combination of dedicated hardware and instructions stored in a non-transitory medium, such as memory 106. The non-transitory medium includes all electronic mediums or media of storage, except signals. Examples of suitable non-transitory computer-readable media include one or more flash memory devices, battery-backed RAM, solid state drives (SSDs), hard disk drives (HDDs), optical media, and/or other memory devices suitable for storing the instructions 108 for the processor 104.

Resource manager 110 may be implemented with a logic circuit, software, and/or instructions, stored in a memory 106 and configured to perform the operations described herein. Resource manager 110 may perform operations such as receiving requests from applications, handling requests, providing requests to shared resource 114, receiving responses to requests from shared resource 114, and providing responses to application.

Queue 112 may include hardware (e.g., implemented with latches/bits and associated logic) and/or software executed by a processor 104 in system 100. Queue 112 may be stored in any memory 106 in system 100. In some examples, queue 112 is configured to store requests for shared resource 114 from applications or devices in system 100. Queue 112 may include any code, data, logic, or instructions to perform the actions described herein, such as sorting requests by priority.

In some examples, resource manager 110 manages queue 112. Queue 112 may be located in resource manager 110 in some examples. Resource manager 110 and queue 112 may exchange data in accordance with examples herein, such as storing and/or retrieving tasks for execution by shared resource 114. A software application may include both resource manager 110 and queue 112 in an example.

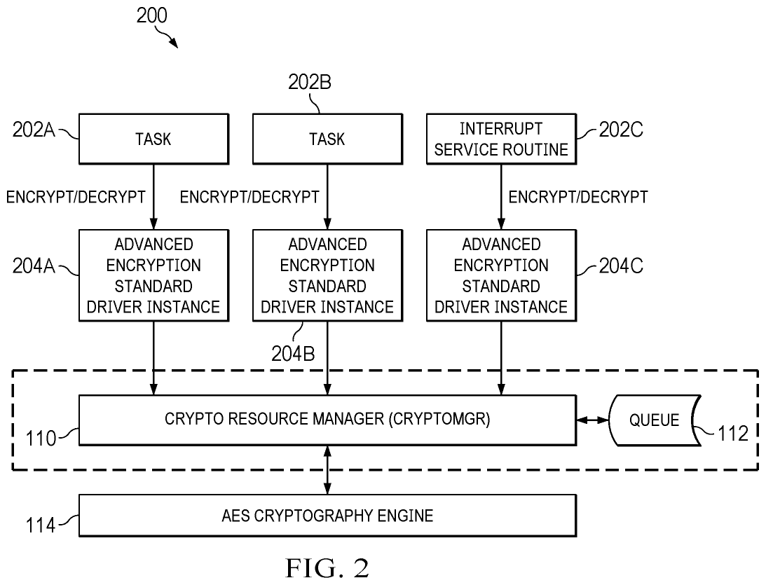

FIG. 2 illustrates a block diagram of a system 200 for sharing a resource in accordance with various examples herein. Some components of system 200 are described above with respect to FIG. 1, and like numerals denote like components. System 200 includes the resource manager 110, queue 112, and shared resource 114. In this example, shared resource 114 is an Advanced Encryption Standard (AES) cryptography engine, and resource manager 110 is a cryptographic resource manager. In other examples, other shared resources 114 may be useful.

System 200 includes tasks 202A, 202B, and 202C (collectively, tasks 202). The tasks are requests sent by various applications, contexts, processors, etc., which are not shown in FIG. 2. The tasks may be requests for shared resource 114 to encrypt or decrypt specific data. System 200 includes driver instances 204A, 204B, and 204C (collectively, driver instances 204, and individually, driver instance 204 e.g., when driver instances 204A, 206, and 206C are implemented as a single driver instance, or when referring to any of driver instances 204A, 204B, and 204C)). Each task 202 opens a driver instance 204. AES driver instances 204A, 204B, and 204C are associated with tasks 202A, 202B, and 202C, respectively. In this example, task 202C is an ISR. The driver instances 204 may be useful for differentiating the tasks. Resource manager 110 uses the driver instances to differentiate among the tasks and determine the priorities available. Resource manager 110 provides the tasks 202 to queue 112. In queue 112, tasks 202 may be stored and then selected by resource manager 110 based on priority. Tasks 202 in queue 112 may be sorted or arranged in some examples. Resource manager 110 may select higher priority tasks for execution by shared resource 114 before lower priority tasks. Tasks 202 may also have attributes attached to them, such as preempt and resume, preempt and reject, or a hold time.

Resource manager 110 may make decisions regarding accepting a request, holding a request, rejecting a request, and preempting currently executing requests. Resource manager 110 may make these decisions based at least in part on the priority of the request, any attributes of the request, and the remaining time of a currently executing request at the shared resource 114. In one example, higher priority requests are selected above lower priority requests. A lower priority request that is currently executing by shared resource 114 may be preempted by a higher priority request. If two tasks have equal priority, they may be handled with round robin scheduling. However, any suitable scheduling may be useful for tasks that have equal priority. Preempted requests may be either resumed or rejected. Some shared resources 114 may support resumption, and some may not. If resumption is supported, resource manager 110 may resume a preempted lower priority request after a higher priority request has completed execution by shared resource 114. If resumption is not supported, resource manager 110 may preempt and reject a currently executing lower priority request. The requestor, such as an application, context, or processor, may be notified by resource manager 110 that the task was preempted. The requestor may then resubmit the task for execution, or may alter the task and submit the altered task for execution.

Some tasks 202 may also include a hold time attribute. The hold time indicates how long a task 202 is willing to wait before execution by the shared resource 114. The hold time may be a time, such as five milliseconds, or a number of clock cycles of a clock signal associated with a processor 104 in system 100. The hold time attribute indicates that a higher priority request will wait until the currently executing (lower priority) request is complete. Then the higher priority request will be executed by the shared resource 114. In some examples, a hold time attribute may advantageously prevent resource thrashing, where the shared resource is continually stopping and starting requests rather than completing requests. The hold time attribute may also allow lower priority requests to be completed without preemption if the request can be completed within the hold time, which can advantageously create more total resource throughput if preemption and resumption is not supported. Rather than preempting and rejecting a lower priority request that is close to completion, the hold time attribute sometimes allows the lower priority request to complete, which can advantageously increase the overall efficiency of the system. Resource manager 110 may monitor the time remaining for currently executing tasks and make the decision to wait or preempt based upon the hold time of a higher priority request.

In examples herein, two or more tasks (such as BLE, Zigbee, or CAN) may operate simultaneously and compete for the same shared resource 114. As one example, task 202A may be BLE while task 202B is Zigbee. BLE and Zigbee may simultaneously use a shared resource 114, such as an antenna or cryptography engine. The systems and method described herein provide for different protocols such as these to share the shared resource 114 and complete their respective operations in accordance with the requirements of their respective protocols.

An AES cryptography engine is any hardware or combination of hardware and software that performs encryption and/or decryption operations as described herein. An AES cryptography engine may couple to a memory 106 (not shown in FIG. 2) to store and retrieve data. The AES cryptography engine may be an ASIC configured to carry out AES operations, or may be general purpose processing hardware programmed with firmware to carry out the AES operations. In system 200, each operation or request may have its own driver instance 204. Each task for a shared resource 114 opens a driver instance 204. The driver instances 204 may be software executed by a processor 104 in one example. A driver handle or name may be used to differentiate the tasks in one example.

The driver instances 204 provide information regarding the tasks to resource manager 110, so resource manager 110 is aware of the number of tasks and the different priorities of the pending tasks.

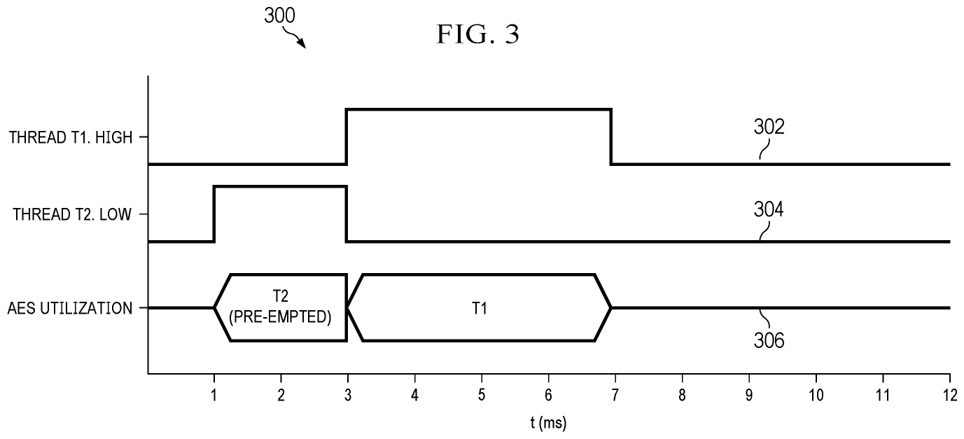

FIG. 3 illustrates a timing diagram 300 of low priority request preemption in accordance with various examples herein. In timing diagram 300, time in milliseconds (ms) is indicated on the x axis. Three waveforms are shown (302, 304, and 306). The times shown in timing diagram 300 are exemplary, and other timing may be useful in other examples.

Waveform 302 indicates a thread T1 (or task) with a high priority. Waveform 304 indicates a thread T2 (or task) with low priority. Waveform 306 represents the shared resource utilization. In this example, shared resource 114 is an AES cryptographic engine, and waveform 306 indicates which task is being executed by the AES cryptographic engine.

In timing diagram 300, at time 1 ms a low priority thread T2 is received by resource manager 110. At this time, the shared resource 114 is free, and therefore thread T2 may begin executing. Waveform 306 indicates that thread T2 begins executing at time 1 ms.

At time 3 ms, a high priority thread T1 is received by resource manager 110. T1 has higher priority than T2, and in this example, T1 is preempted. Waveform 306 shows that at time 3 ms, thread T2 is preempted and thread T1 begins executing. Because thread T1 is high priority, shared resource 114 executes thread T1 until it is complete at about time 7 ms. Timing diagram 300 therefore provides an example of preempting a low priority request responsive to receiving a higher priority request. In examples herein, if thread T2 is preempted, thread T2 may be resumed or rejected. If thread T2 is resumed, shared resource 114 may resume execution of thread T2 after thread T1 is completed (not shown in FIG. 3). If thread T2 is rejected, resource manager 110 may notify the requestor of thread T2 that thread T2 was rejected, and thread T2 should be requested again. The requestor of thread T2 may resubmit a request that is identical to thread T2 to resource manager 110, or the requestor may adjust or modify the thread T2 and submit the modified request to resource manager 110.

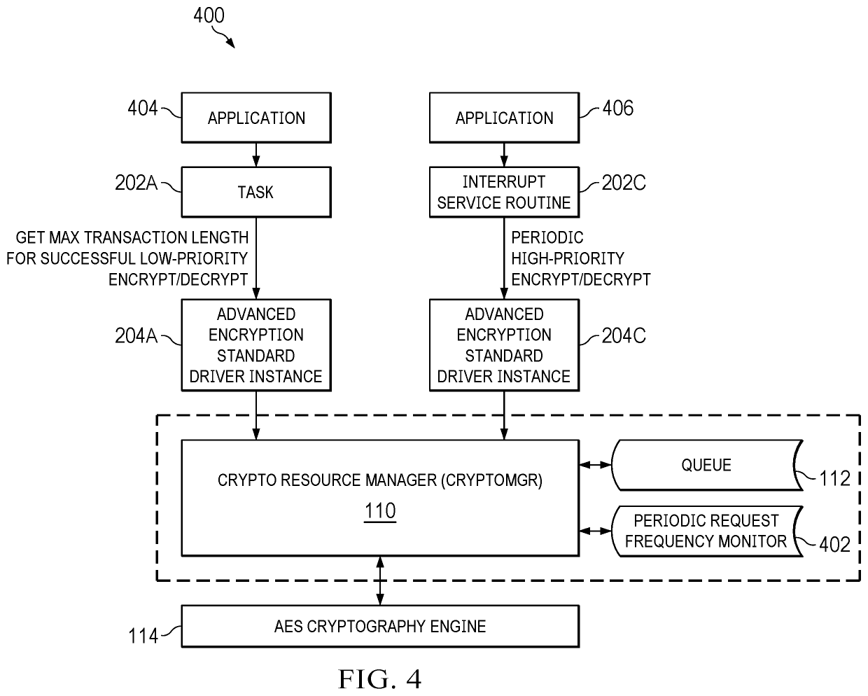

FIG. 4 illustrates a block diagram of a system 400 for sharing a resource with frequency monitoring in accordance with various examples herein. Some components of system 400 are described above with respect to FIG. 2, and like numerals denote like components. System 400 includes the resource manager 110, queue 112, and shared resource 114. In this example, shared resource 114 is an AES cryptography engine, and resource manager 110 is a cryptographic resource manager. In other examples, other shared resources 114 may be useful. System 400 also includes tasks 202A and 202C, and driver instances 204A and 204C. System 400 includes periodic request frequency monitor 402 in this example. System 400 also includes applications 404 and 406. Applications 404 and 406 may be executed in one or more processors, such as processor 104A and/or 104B (not shown in FIG. 4). In an example, applications 404 and 406 may be requestors that send requests for shared resource 114.

In system 400, periodic request frequency monitor 402 is configured to monitor the frequency of high priority requests. In this example, task 202C represents a series of ISRs, which are high priority requests for shared resource 114, that are requested by a requestor such as application 406. Task 202A represents a series of requests that are low priority requests for shared resource 114, and which are requested by a requestor such as application 404. Therefore, in this example, tasks 202C from application 406 may periodically interrupt tasks 202A from application 404, because the tasks 202C are higher priority.

Periodic request frequency monitor 402 may be data, code, logic, or instructions that are executed by a processor, such as a processor 104 (shown in FIG. 1). Periodic request frequency monitor 402 monitors the high priority requests received by resource manager 110, such as tasks 202C, which are ISRs in this example. Periodic request frequency monitor 402 monitors the requests to determine if a pattern of high priority requests exists. For example, periodic request frequency monitor 402 may determine that a high priority request is received every 20 ms from application 406. In another example, periodic request frequency monitor 402 may determine that a high priority request is received between every 40 to 50 ms. In another example, periodic request frequency monitor 402 may determine that three high priority requests are received every 20 ms, then no high priority requests are received for 100 ms, then three high priority requests are received every 20 ms, then no high priority requests are received for 100 ms, and so on in a recurring pattern. Periodic request frequency monitor 402 may use any suitable algorithm, code, data, software, or logic to determine patterns of high priority requests.

If periodic request frequency monitor 402 determines that the high priority requests from application 406 have a pattern, resource manager 110 may provide the pattern or an indication of the pattern to the requestor of a low priority task, such as application 404. As an example, if periodic request frequency monitor 402 determines that high priority requests are received about every 20 ms on average, resource manager 110 may notify application 404, when a low priority task 202A is preempted, that the tasks 202A are too long to complete before being interrupted by a higher priority task (e.g., by using a flag such as the assertion of a bit or signal). Responsive to the notification, application 404 may send shorter tasks 202A for shared resource 114. In another example, resource manager 110 may notify application 404 that its lower priority tasks should complete within 20 ms to have a greater chance of completion without interruption. In response, application 404 may shorten its low priority requests so they complete in under 20 ms to have a greater chance to avoid preemption.

In another example, resource manager 110 may determine that three high priority requests are received every 20 ms, then no high priority requests are received for 100 ms, and so on in a recurring pattern. Resource manager 110 could notify application 404 that at a certain time, there is likely to be a duration of 100 ms where no high priority requests are received. Responsive to the notification, application 404 can decide to send low priority requests of a duration less than 100 ms that can then be scheduled by the resource manager to be executed during the 100 ms window to increase the likelihood of the low priority requests completing. A window such as this 100 ms window may be referred to as a maximum duration of availability for the shared resource 114. The window indicates the duration that the shared resource 114 may be available for lower priority tasks. The window may also be referred to as a maximum available transaction length in some examples. The window indicates the maximum transaction length that an application, such as application 404, should request for a low priority task to reduce the likelihood of preemption. In some examples, any transaction length longer than this may be immediately rejected by the resource manager 110.

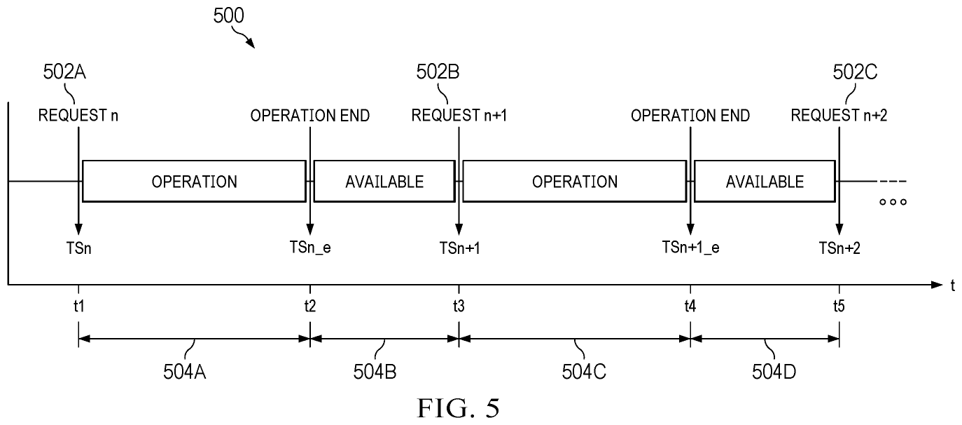

FIG. 5 illustrates diagram 500 of periodic request frequency monitoring in accordance with various examples herein. Diagram 500 shows example high priority requests n, n+1, n+2, etc., received by resource manager 110. The requests may be received by resource manager 110 from applications, processors, contexts, etc., or from queue 112. The x-axis of diagram 500 indicates the times that the high priority requests are received, and the times that the high priority requests are completed by shared resource 114.

In an example, high priority request n 502A is received at time t1 (e.g., time stamp n (TSn)). Shared resource 114 executes high priority request n 502A during time duration 504A, which begins at time t₁ (TSn) and ends at time t₂ (time stamp n end (TSn_e)). At time t₂, shared resource 114 does not have another request to execute, so shared resource 114 is available between times t₂ and t₃ (e.g., time duration 504B).

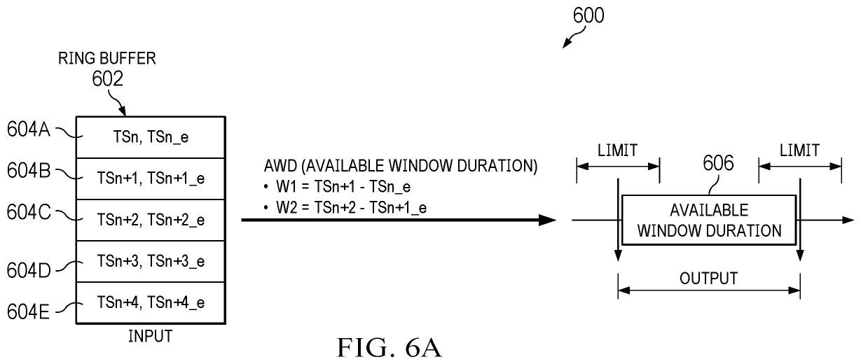

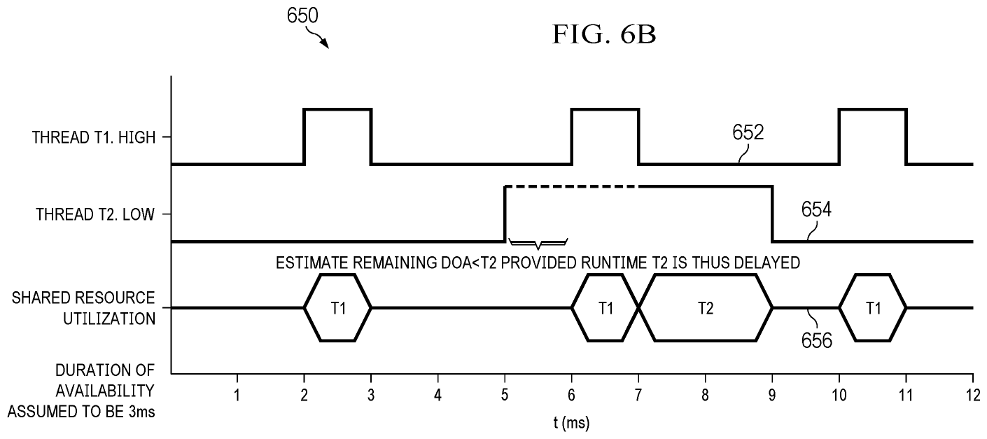

At time t₃, high priority request n+1 502B is received (time stamp TSn+1). Shared resource 114 executes high priority request n+1 502B during time duration 504C, which begins at time t₃ (TSn+1) and ends at time t₄ (time stamp n+1 end (TSn+1_e)). At time t₄, shared resource 114 does not have another request to execute, so shared resource 114 is available between times t₄ and t₅ (e.g., time duration 504D). At time t₅, high priority request N+2 502C is received (time stamp TSn+2). The high priority requests and associated time stamps shown in this example are monitored by periodic request frequency monitor 402 to determine if a pattern exists in the high priority requests. In this example, periodic request frequency monitor 402 determines the pattern and an available window duration, e.g., as described with respect to FIG. 6A below.

FIG. 6A illustrates system 600 for determining an available window duration in accordance with various examples herein. System 600 includes a ring buffer 602 having multiple entries (604A, 604B, 604C, 604D, and 604E, in this example). System 600 also includes an output 606 (e.g., an output register), that provides an available window duration (AWD). The operations described with respect to FIG. 6A may be performed by resource manager 110, periodic request frequency monitor 402, or a combination of these components.

To begin, the time stamps as identified in FIG. 5 described above are stored in ring buffer 602. Ring buffer 602 may be stored in any suitable memory or may be implemented in hardware in some examples. The depth of ring buffer 602 may be configured to any suitable depth. In ring buffer 602, each entry 604 includes a start time for a request and an end time for the request. For example, entry 604A includes the start time for request n 502A (TSn) and the end time for request n 502A (TSn_e). Likewise, entry 604B includes the start time for request n+1 502B (TSn+1) and the end time for request n+1 502B (TSn+1_e). In this example, ring buffer 602 includes start and end times for five requests (n, n+1, n+2, n+3, and n+4).

After a suitable number of time stamps are stored in ring buffer 602, available window durations may be calculated for the pattern of high priority requests. Any suitable hardware or software may calculate the available window durations. The available window durations are the times between the end of one high priority operation (e.g., request n's) and the beginning of the next high priority request (e.g., request n+1). As one example, window 1 (W1) equals TSn+1−TSn_e. Window 2 (W2) equals TSn+2−TSn+1_e. The window durations are calculated for each of the available time stamps in ring buffer 602.

Next, the calculated window durations are checked to see if they are within a configurable limit. For example, a first window duration may be 19 ms, a second may be 20 ms, a third may be 19.5 ms, and a fourth may be 20.5 ms. These window durations are all about, but not exactly 20 ms. Therefore, to detect a pattern, the pattern detection algorithm may determine that a pattern is detected if all the window durations fall within the range of 18 to 21 ms. If so, a pattern is detected. If any of the window durations are smaller than 18 ms or larger than 21 ms, no pattern is detected, and the ring buffer 602 may be cleared. The process may then begin again by storing time stamps for new high priority requests in the ring buffer 602 and performing another pattern detection. The range for the pattern detection, such as 18 ms to 21 ms, may also be configurable. A smaller range may make the pattern detection more precise, but may result in fewer patterns being detected. A larger range makes it more likely that a pattern is detected, but the larger range may be less useful for an application that sends lower priority requests, as preemption could occur more frequently with a larger range.

After the window durations are calculated and the pattern is determined, the window duration may be converted to a data packet size that can be executed/processed by the shared resource 114 within the available window duration. As one example, the shared resource 114 may be a cryptographic engine that can encrypt or decrypt a certain data packet size within the available window. In another example, the shared resource 114 may be an antenna that can transmit a certain data packet size within the available window.

If a lower priority request is preempted after the available window duration has been determined, the available window duration may be provided to the requestor along with the rejection of the lower priority request. If the requestor decides to resubmit the lower priority request, the requestor can check if the data packet size is equal to or smaller than the available window duration. If the data packet size is smaller, the requestor can resubmit the lower priority request. If the data packet size is larger than the available window duration, the requestor can adjust the request so the data packet size of the adjusted or revised request fits within the available window duration and then resubmit the request. The lower priority request may also be resubmitted with a preempt and resume attribute if resumption is supported by shared resource 114.

FIG. 6B is a timing diagram 650 describing a duration of availability notification by resource manager 110 in accordance with various examples herein. In this example, resource manager 110 estimates the remaining time left to run a low priority operation. In timing diagram 650, time in ms is indicated on the x-axis. Three waveforms 652, 654, and 656 are shown.

Waveform 652 indicates a thread T1 (or task) with a high priority that occurs periodically. The thread T1 occurs every 4 ms and takes 1 ms to complete in this example. Using an algorithm similar to the one described herein, the duration of availability in this example is assumed to be 3 ms.

At time 5 ms, a low priority thread T2 submits a request that is received by resource manager 110. T2 also submits the duration of its operation as 2 ms, which falls within the duration of availability, but T2 also contains the preempt and cancel attribute. The resource manager 110 may estimate whether the request T2 can run to completion in the time remaining before the next T1 is expected. Based on the assumptions, and the recording of T1's completion at time 3 ms, resource manager 110 estimates that the next high priority request will happen at time 6 ms. Therefore, the estimated time remaining for T2 to complete is only 1 ms, which is not sufficient to complete the 2 ms operation. Thus, T2 is delayed until it can run to completion.

Waveforms 654 and 656 show that when T1 has completed again at time 7 ms, T2 can then be scheduled and run to completion without being preempted by T1. In this way, the resource manager 110 is responsible for the running of the tasks such that short enough tasks may complete in the duration of availability (e.g., within a duration of availability window). Therefore, the requestor of the task does not have to submit the request at a specific time in order to run to completion.

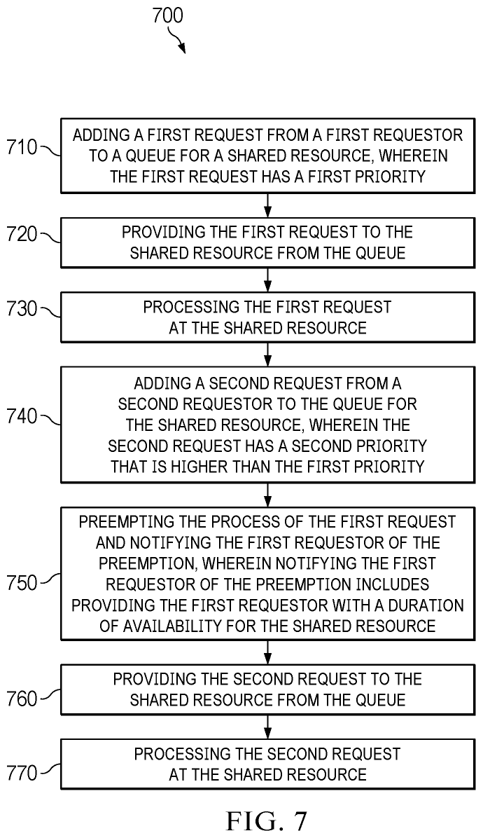

FIG. 7 illustrates a flow diagram of method 700 for sharing a resource in accordance with various examples herein. The steps of method 700 may be performed in any suitable order. The hardware components described above with respect to FIGS. 1, 2, and 4 may perform method 700 in some examples. Any suitable hardware or digital logic may perform method 700 in some examples. The steps performed by resource manager 110 in method 700 may be performed by any suitable processor 104.

Method 700 begins at 710, where a processor (e.g., processor(s) 104) adds a first request from a first requestor to a queue (e.g., 112) for a shared resource (e.g., 114), where the first request has a first priority. The requestor may be an application, context, processor, processing core, controller, or device. The shared resource may be a processor, cryptographic engine, antenna, or any other shared resource 114.

Method 700 continues at 720, where the resource manager 110 provides the first request to the shared resource 114 from the queue 112. Method 700 continues at 730, where the shared resource 114 processes the first request.

Method 700 continues at 740, where the processor (e.g., the same processor that performed step 710 or a different processor) adds a second request from a second requestor to the queue 112 for the shared resource 114. The second request has a second priority that is higher than the first priority.

Method 700 continues at 750, where the resource manager 110 preempts the processing of the first request and notifies the first requestor of the preemption. In an example, notifying the first requestor of the preemption includes providing the first requestor with a duration of availability for the shared resource 114 or an indication (e.g., a flag) that the duration of the rejected first request is too long.

Method 700 continues at 760, where the second request is provided to shared resource 114 from the queue 112 by the resource manager 110. Method 700 continues at 770, where the shared resource 114 processes the second request.

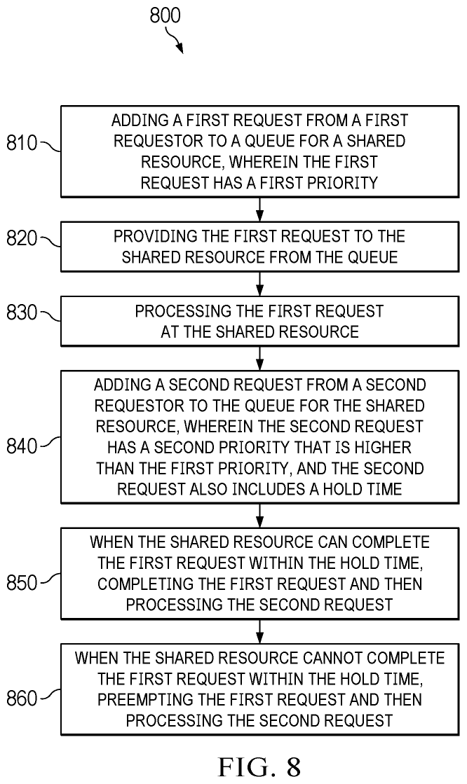

FIG. 8 illustrates a flow diagram of method 800 for sharing a resource in accordance with various examples herein. The steps of method 800 may be performed in any suitable order. The hardware components described above with respect to FIGS. 1, 2, and 4 may perform method 800 in some examples. Any suitable hardware or digital logic may perform method 800 in some examples. The steps performed by resource manager 110 in method 800 may be performed by any suitable processor 104.

Method 800 begins at 810, where a processor (e.g., processor(s) 104) adds a first request from a first requestor to a queue (e.g., 112) for a shared resource (e.g., 114), where the first request has a first priority. The requestor may be an application, context, processor, or device. The shared resource may be a processor, cryptographic engine, antenna, or any other shared resource 114. In some examples, a resource manager 110 (e.g., 110) may receive the request from the first requestor and place the request in a queue (e.g., 112).

Method 800 continues at 820, where a resource manager (e.g., 110) provides the first request to the shared resource 114 from the queue 112. Method 800 continues at 830, where the shared resource 114 processes the first request.

Method 800 continues at 840, where a processor (e.g., the same processor that performed step 810 or a different processor) adds a second request from a second requestor to the queue 112 for the shared resource 114, where the second request has a second priority that is higher than the first priority, and the second request also includes a hold time. In this example, the second request may have a high priority, and also include a hold time attribute indicating a duration of maximum wait time for the currently executing request to complete.

Method 800 continues at 850 where the shared resource 114 completes the first request and then processes the second request if the first request can be completed within the hold time. Therefore, in this example, a lower priority request may be completed by the shared resource 114 if it can be completed within the hold time of a higher priority request. This feature may advantageously provide more efficient operation and prevent resource thrashing.

Method 800 continues at 860, where the resource manager 110 preempts the first request and processes the second request if the shared resource cannot complete the first request within the hold time.

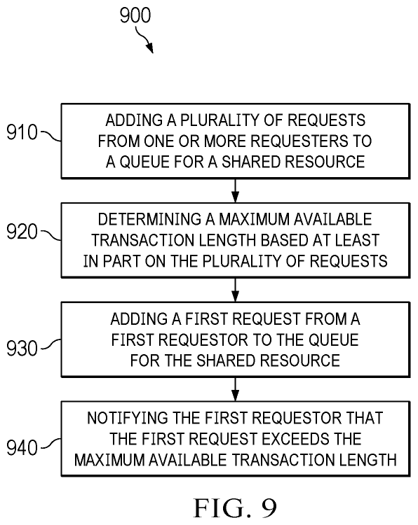

FIG. 9 illustrates a flow diagram of method 900 for sharing a resource in accordance with various examples herein. The steps of method 900 may be performed in any suitable order. The hardware components described above with respect to FIGS. 1, 2, and 4 may perform method 900 in some examples. Any suitable hardware or digital logic may perform method 900 in some examples. The steps performed by resource manager 110 in method 900 may be performed by any suitable processor 104.

Method 900 begins at 910, where a resource manager (e.g., 110) adds a plurality of requests from one or more requestors to a queue (e.g., 112) for a shared resource (e.g., 114).

Method 900 continues at 920, where a processor (e.g., processor (s)104) determines a maximum available transaction length based at least in part on the plurality of requests. Any suitable software, code, algorithm, or instructions may be used to determine the maximum available transaction length.

Method 900 continues at 930, where the resource manager 110 adds a first request from a first requestor to the queue 112 for the shared resource 114. In this example, the first request is a low priority request. Method 900 continues at 940, where the resource manager 110 notifies the first requestor that the first request exceeds the maximum available transaction length. Responsive to the notification, the first requestor may resubmit a modified first request that fits within the maximum available transaction length.

In the examples described herein, multiple requestors may send requests to a resource manager for a shared resource. The shared resource may be an antenna, a cryptographic engine, a specialized processor, or any other shared resource. In some examples, lower priority requests may be preempted by a higher priority request. If the shared resource supports resumption of a preempted request, the lower priority request may be resumed and executed after the higher priority request completes, if no other higher priority requests have been received in the interim. If the shared resource doesn't support preemption and resumption, the lower priority request is rejected and the requestor may be notified. The requestor may re-submit the lower priority request. In some examples, the requestor may re-submit the lower priority request with a shorter duration, length, or execution time to attempt to avoid preemption again (e.g., based on a notification from the resource manager that the duration of the request was too long). In some examples, the resource manager may suggest a duration of availability to the requestor. If a pattern of high priority requests is determined, and a duration of availability is found, the resource manager may reject a lower priority request and notify the requestor of the duration of availability. The requestor may then re-submit, or alter and re-submit, the lower priority request for the shared resource.

The examples herein allow a resource to be shared among multiple requestors, rather than duplicating resources. This approach may advantageously result in lower implementation costs and lower power consumption. The use of a queue and priority for the requests may advantageously provide a real-time guarantee for critical operations (high priority requests), and the deterministic use of the shared resource. In some examples, higher priority requests can be guaranteed timely execution without waiting behind lower priority requests. Also, the features described herein may advantageously allow for lower priority requests to be executed in the presence of higher priority requests by identifying patterns, allowing preemption and resume, and/or providing durations of availability so the lower priority requests may be adjusted or revised to fit within the available windows.

Example embodiments of the present disclosure are summarized here. Other embodiments can also be understood from the entirety of the specification and the claims filed herein.

Example 1. A method, including: adding a first request from a first requestor to a queue for a shared resource, where the first request has a first priority; providing the first request to the shared resource from the queue; processing the first request at the shared resource; adding a second request from a second requestor to the queue for the shared resource, where the second request has a second priority that is higher than the first priority; preempting the processing of the first request and notifying the first requestor of the preemption, where notifying the first requestor of the preemption includes providing the first requestor with a duration of availability for the shared resource; providing the second request to the shared resource from the queue; and processing the second request at the shared resource.

Example 2. The method of example 1, further including: after notifying the first requestor of the preemption, resending the first request from the first requestor to the queue for the shared resource, where the first request fits within the duration of availability.

Example 3. The method of one of examples 1 or 2, where resending the first request includes altering the first request to fit within the duration of availability.

Example 4. The method of one of examples 1 to 3, where the shared resource is a cryptographic engine.

Example 5. The method of one of examples 1 to 4, where the first request is associated with a Bluetooth® Low Energy protocol.

Example 6. The method of one of examples 1 to 5, where the second request is associated with a Zigbee protocol.

Example 7. The method of one of examples 1 to 6, further including: receiving a third request with a third priority at the queue; receiving a fourth request with a fourth priority at the queue; when the third priority is higher than the fourth priority, complete the third request first with the shared resource; when the fourth priority is higher than the third priority, complete the fourth request first with the shared resource; and when the third priority and the fourth priority are equal, complete the third request and the fourth request with round robin scheduling.

Example 8. A method, including: adding a first request from a first requestor to a queue for a shared resource, where the first request has a first priority; providing the first request to the shared resource from the queue; processing the first request at the shared resource; adding a second request from a second requestor to the queue for the shared resource, where the second request has a second priority that is higher than the first priority, and the second request also includes a hold time; when the shared resource can complete the first request within the hold time, completing the first request and then processing the second request; and when the shared resource cannot complete the first request within the hold time, preempting the first request and then processing the second request.

Example 9. The method of example 8, where the shared resource is a cryptographic engine.

Example 10. The method of one of examples 8 or 9, where the shared resource is an antenna.

Example 11. A method, including: adding a plurality of requests from one or more requestors to a queue for a shared resource; determining a maximum available transaction length based at least in part on the plurality of requests; adding a first request from a first requestor to the queue for the shared resource; and notifying the first requestor that the first request exceeds the maximum available transaction length.

Example 12. The method of example 11, further including: notifying the first requestor of the maximum available transaction length.

Example 13. The method of one of examples 11 or 12, further including: adding a revised request from the first requestor to the queue for the shared resource, where the revised request fits within the maximum available transaction length.

Example 14. The method of one of examples 11 to 13, where the revised request is scheduled to execute when its transaction length fits within an estimated duration of availability window.

Example 15. The method of one of examples 11 to 14, further including: adding a second request from a second requestor to the queue for the shared resource, where the second request includes a hold time; when the shared resource can complete a currently executing request within the hold time, completing the currently executing request and then processing the second request; and when the shared resource cannot complete the currently executing request within the hold time, preempting the currently executing request and then processing the second request.

Example 16. The method of one of examples 11 to 15, further including: responsive to preempting the currently executing request, notifying a requestor of the currently executing request that the currently executing request was preempted.

Example 17. The method of one of examples 11 to 16, further including: after processing the second request, resuming processing of the currently executing request.

Example 18. A system, including: a processor configured to: add a first request from a first requestor to a queue for a shared resource, where the first request has a first priority; add a second request from a second requestor to the queue for the shared resource, where the second request has a second priority that is higher than the first priority; receive a notification that the first request was preempted; and responsive to receiving the notification, add the first request to the queue again for the shared resource.

Example 19. The system of example 18, where the processor is further configured to: add a plurality of requests from one or more requestors to the queue for the shared resource; and determine a maximum available transaction length based at least in part on the plurality of requests.

Example 20. The system of one of examples 18 or 19, where the shared resource is a cryptographic engine.

Example 21. The system of one of examples 18 to 20, where adding the first request again includes adding a revised first request with a shorter length.

Example 22. The system of one of examples 18 to 21, where the notification includes a maximum available transaction length for the shared resource.

Example 23. The system of one of examples 18 to 22, where the second request includes a hold time.

Example 24. The system of one of examples 18 to 23, where the processor and the shared resource are integrated in a same integrated circuit.

In this description, unless otherwise stated, “about,” “approximately” or “substantially” preceding a parameter means being within +/−10 percent of that parameter. Modifications are possible in the described examples, and other examples are possible within the scope of the claims.

What is claimed is:

1. A method, comprising:
adding a first request from a first requestor to a queue for a shared resource, wherein the first request has a first priority;
providing the first request to the shared resource from the queue;
processing the first request at the shared resource;
adding a second request from a second requestor to the queue for the shared resource, wherein the second request has a second priority that is higher than the first priority;
preempting the processing of the first request and notifying the first requestor of the preemption, wherein notifying the first requestor of the preemption includes providing the first requestor with a duration of availability for the shared resource;
providing the second request to the shared resource from the queue; and
processing the second request at the shared resource.

2. The method of claim 1, further comprising:
after notifying the first requestor of the preemption, resending the first request from the first requestor to the queue for the shared resource, wherein the first request fits within the duration of availability.

3. The method of claim 2, wherein resending the first request includes altering the first request to fit within the duration of availability.

4. The method of claim 1, wherein the shared resource is a cryptographic engine.

5. The method of claim 1, wherein the first request is associated with a Bluetooth® Low Energy protocol.

6. The method of claim 5, wherein the second request is associated with a Zigbee protocol.

7. The method of claim 1, further comprising:
receiving a third request with a third priority at the queue;
receiving a fourth request with a fourth priority at the queue;
when the third priority is higher than the fourth priority, complete the third request first with the shared resource;
when the fourth priority is higher than the third priority, complete the fourth request first with the shared resource; and
when the third priority and the fourth priority are equal, complete the third request and the fourth request with round robin scheduling.

8. A method, comprising:
adding a first request from a first requestor to a queue for a shared resource, wherein the first request has a first priority;
providing the first request to the shared resource from the queue;
processing the first request at the shared resource;
adding a second request from a second requestor to the queue for the shared resource, wherein the second request has a second priority that is higher than the first priority, and the second request also includes a hold time;
when the shared resource can complete the first request within the hold time, completing the first request and then processing the second request; and
when the shared resource cannot complete the first request within the hold time, preempting the first request and then processing the second request.

9. The method of claim 8, wherein the shared resource is a cryptographic engine.

10. The method of claim 8, wherein the shared resource is an antenna.

11. A method, comprising:
adding a plurality of requests from one or more requestors to a queue for a shared resource;
determining a maximum available transaction length based at least in part on the plurality of requests;
adding a first request from a first requestor to the queue for the shared resource; and
notifying the first requestor that the first request exceeds the maximum available transaction length.

12. The method of claim 11, further comprising:
notifying the first requestor of the maximum available transaction length.

13. The method of claim 11, further comprising:
adding a revised request from the first requestor to the queue for the shared resource, wherein the revised request fits within the maximum available transaction length.

14. The method of claim 13, wherein the revised request is scheduled to execute when its transaction length fits within an estimated duration of availability window.

15. The method of claim 11, further comprising:
adding a second request from a second requestor to the queue for the shared resource, wherein the second request includes a hold time;
when the shared resource can complete a currently executing request within the hold time, completing the currently executing request and then processing the second request; and
when the shared resource cannot complete the currently executing request within the hold time, preempting the currently executing request and then processing the second request.

16. The method of claim 15, further comprising:
responsive to preempting the currently executing request, notifying a requestor of the currently executing request that the currently executing request was preempted.

17. The method of claim 15, further comprising:
after processing the second request, resuming processing of the currently executing request.

18. A system, comprising:
a processor configured to:
add a first request from a first requestor to a queue for a shared resource, wherein the first request has a first priority;
add a second request from a second requestor to the queue for the shared resource, wherein the second request has a second priority that is higher than the first priority;
receive a notification that the first request was preempted; and
responsive to receiving the notification, add the first request to the queue again for the shared resource.

19. The system of claim 18, wherein the processor is further configured to:
add a plurality of requests from one or more requestors to the queue for the shared resource; and
determine a maximum available transaction length based at least in part on the plurality of requests.

20. The system of claim 18, wherein the shared resource is a cryptographic engine.

21. The system of claim 18, wherein adding the first request again includes adding a revised first request with a shorter length.

22. The system of claim 18, wherein the notification includes a maximum available transaction length for the shared resource.

23. The system of claim 18, wherein the second request includes a hold time.

24. The system of claim 18, wherein the processor and the shared resource are integrated in a same integrated circuit.
